(19) United States
(12) Patent Application Publication
(10) Pub. No.: US 2026/0335690 A1
(43) Pub. Date: Oct. 29, 2026

(54) FIELD-REPLACEABLE LINE FOR SELF-RETRACTING LIFELINE (SRL)

(71) Applicant: Alexander Andrew, Inc., Compton, CA (US)

(72) Inventors: John F. Aldrich, Solvang, CA (US); Martin R. Sevilla, Rancho Santa Margarita, CA (US)

(21) Appl. No.: 19/192,618

(22) Filed: Apr. 29, 2025

(51) Int. Cl. A62B 35/00; A62B 1/06

(52) U.S. Cl. CPC A62B 35/0093; A62B 1/06; A62B 35/0043

(57) ABSTRACT

A self-retracting lifeline (SRL) with a field-replaceable lifeline includes a housing configured to enclose a retractable cable removably connected to a field-replaceable lifeline. An orifice component is removably connected to the housing through which the field-replaceable lifeline extends. A removable coupling component secures the lifeline and is retained by the orifice component within the housing. The coupling component provides for removing and replacing of the field-replaceable lifeline.

### BACKGROUND

### Field

The embodiments relate to fall protection self-retracting lifelines (SRLs), and in particular to field-replaceable line for fall protection SRLs.

### Description of the Related Art

Workers that work in elevated environments may employ fall protection gear, such as SRLs. If a fall event occurs with an SRL, conventional SRLs must be either retired or sent to a repair center for replacement and recertification.

### SUMMARY

Some embodiments relate to fall protection self-retracting lifelines (SRLs), and in particular to SRLs that include a field-replaceable lifeline (or line). One embodiment provides an SRL with a field-replaceable lifeline includes a housing configured to enclose a retractable cable removably connected to a field-replaceable lifeline. An orifice component is removably connected to the housing through which the field-replaceable lifeline extends. A removable coupling component secures the lifeline and is retained by the orifice component within the housing. The coupling component provides for removing and replacing of the field-replaceable lifeline.

Another embodiment provides an SRL system that includes a cable having a first end coupled to a retracting drum component of the SRL within a housing, and a second end coupled to a drum-side jacket of a coupling component. An orifice component is removably coupled to the housing through which a field-replaceable lifeline extends. The coupling component secures the field-replaceable lifeline within the housing and is retained by the orifice component. The coupling component provides for removing and replacing the field-replaceable lifeline.

Still another embodiment provides a method for replacing a damaged lifeline in a SRL that includes removing housing fasteners to release an orifice component from the housing. The orifice is extracted from the housing. The damaged lifeline is pulled from the SRL, exposing a coupling component. The damaged lifeline is secured with a specialized tool that engages a drum-side jacket of the coupling component. One or more locking fasteners are detached from the coupling component. A locking ring of the coupling component is removed and a hook-side jacket is disengaged from the drum-side jacket. The damaged lifeline is extracted from a counterbore portion of the hook-side jacket. A replacement lifeline is inserted through the counterbore portion. The replacement lifeline is secured by re-engaging the locking ring and the one or more locking fasteners. The specialized tool is removed for reinserting the coupling component within the housing. The orifice component is reinserted into the housing. The housing fasteners are resecured to the orifice component to complete the replacement.

Other aspects and advantages of the present invention will become apparent from the following detailed description, which, when taken in conjunction with the drawings, illustrate by way of example the principles of the invention.

### BRIEF DESCRIPTION OF THE DRAWINGS

The embodiments are illustrated by way of example, and not by way of limitation, in the Figures of the accompanying drawings and in which like reference numerals refer to similar elements and in which:

FIG. 1 illustrates an example self-retracting lifeline (SRL) with a field-replaceable damaged lifeline from a fall event, according to some embodiments;

FIG. 2 illustrates the example SRL with the field-replaceable damaged lifeline from a fall event with housing fasteners removed from the housing and orifice, according to some embodiments;

FIG. 3 illustrates the example SRL with the field-replaceable damaged lifeline from a fall event with an orifice removed from the housing, according to some embodiments;

FIG. 4 illustrates the example SRL with the field-replaceable damaged lifeline from a fall event with the cable pulled out of the SRL showing a coupling component that includes a hook-side jacket and a drum side jacket removed from the drum-side of the SRL, according to some embodiments;

FIG. 5 illustrates the example SRL with the field-replaceable damaged lifeline from a fall event with a specialized tool used to retain the cable outside of the SRL housing, according to some embodiments;

FIG. 6 illustrates the example SRL with the field-replaceable damaged lifeline from a fall event with the cable released to seat the coupling component into the specialized tool, according to some embodiments;

FIG. 7 illustrates the example SRL with the field-replaceable damaged lifeline from a fall event with a lock fastener removed from the coupling component, according to some embodiments;

FIG. 8 illustrates the example SRL with the field-replaceable damaged lifeline from a fall event with a locking ring moved away from the coupling component, according to some embodiments

FIG. 9 illustrates the example SRL with the field-replaceable damaged lifeline from a fall event with a locking pin removed from the locking pin opening of the drum-side jacket, according to some embodiments;

FIG. 10 illustrates the example SRL with the field-replaceable damaged lifeline from a fall event with a hook-side of the jacket removed from the drum-side jacket, according to some embodiments;

FIG. 11 illustrates the example SRL with the field-replaceable damaged lifeline from a fall event with the damage line moved out of a counterbore portion of the hook-side jacket, according to some embodiments;

FIG. 12 illustrates the example SRL with the field-replaceable damaged lifeline from a fall event removed from the hook-side jacket through the counterbore portion, according to some embodiments;

FIG. 13 illustrates the example SRL with the field-replaceable damaged lifeline removed, according to some embodiments;

FIG. 14 illustrates the example SRL with a new line replacing the damaged line, with the new line inserted through the orifice and the locking ring component, according to some embodiments;

FIG. 15 illustrates the example SRL with the new line moved through the counterbore portion of the hook-side jacket, according to some embodiments;

FIG. 16 illustrates the example SRL with the new line seated into the counterbore portion of the hook-side jacket, according to some embodiments;

FIG. 17 illustrates the example SRL with the new line with the hook-side jacket inserted into the drum-side jacket, according to some embodiments;

FIG. 18 illustrates the example SRL with the new line with the locking component inserted through both the hook-side jacket and the drum-side jacket, according to some embodiments;

FIG. 19 illustrates the example SRL with the new line with the locking component threaded on the hook-side jacket to align a portion with an opening of the drum-side jacket, according to some embodiments;

FIG. 20 illustrates the example SRL with the new line with the lock fastener inserted through both the hook-side jacket and the drum-side jacket, according to some embodiments;

FIG. 21 illustrates the example SRL with the new line with the specialized tool removed, according to some embodiments;

FIG. 22 illustrates the example SRL with the new line with the coupling component retracted back into the housing, according to some embodiments;

FIG. 23 illustrates the example SRL with the new line with the orifice inserted back into the housing, according to some embodiments;

FIG. 24 illustrates the example SRL with the new line with the housing fasteners inserted back into the housing securing the orifice, according to some embodiments; and

FIG. 25 illustrates another SRL with a field-replaceable lifeline with another embodiment of an orifice component, according to some embodiments.

### DETAILED DESCRIPTION

The following description is made for the purpose of illustrating the general principles of the invention and is not meant to limit the inventive concepts claimed herein. Further, particular features described herein can be used in combination with other described features in each of the various possible combinations and permutations. Unless otherwise specifically defined herein, all terms are to be given their broadest possible interpretation including meanings implied from the specification as well as meanings understood by those skilled in the art and/or as defined in dictionaries, treatises, etc.

The description may disclose several preferred embodiments of fall protection web harness systems including protection elements and adjustable accessory configurations, as well as operation and/or component parts thereof. While the following description will be described in terms of fall protection web harness belts, systems and devices for clarity and to place the invention in context, it should be kept in mind that the teachings herein may have broad application to all types of systems, devices and applications.

Some embodiments relate to fall protection self-retracting lifelines (SRLs), and in particular to SRLs that include a field-replaceable lifeline (or line). One embodiment provides an SRL with a field-replaceable lifeline includes a housing configured to enclose a retractable cable removably connected to a field-replaceable lifeline. An orifice component is removably connected to the housing through which the field-replaceable lifeline extends. A removable coupling component secures the lifeline and is retained by the orifice component within the housing. The coupling component provides for removing and replacing of the field-replaceable lifeline.

Another embodiment provides an SRL system that includes a cable having a first end coupled to a retracting drum component of the SRL within a housing, and a second end coupled to a drum-side jacket of a coupling component. An orifice component is removably coupled to the housing through which a field-replaceable lifeline extends. The coupling component secures the field-replaceable lifeline within the housing and is retained by the orifice component. The coupling component provides for removing and replacing the field-replaceable lifeline.

Still another embodiment provides a method for replacing a damaged lifeline in a SRL that includes removing housing fasteners to release an orifice component from the housing. The orifice is extracted from the housing. The damaged lifeline is pulled from the SRL, exposing a coupling component. The damaged lifeline is secured with a specialized tool that engages a drum-side jacket of the coupling component. One or more locking fasteners are detached from the coupling component. A locking ring of the coupling component is removed and a hook-side jacket is disengaged from the drum-side jacket. The damaged lifeline is extracted from a counterbore portion of the hook-side jacket. A replacement lifeline is inserted through the counterbore portion. The replacement lifeline is secured by re-engaging the locking ring and the one or more locking fasteners. The specialized tool is removed for reinserting the coupling component within the housing. The orifice component is reinserted into the housing. The housing fasteners are resecured to the orifice component to complete the replacement.

One or more embodiments relate to a self-retracting lifeline (SRL) with a field-replaceable line, specifically designed to allow the user to replace a damaged lifeline resulting from a fall event without the need to replace the entire SRL unit. Some embodiments described herein provide a process for replacing the damaged line, including the disassembly and reassembly of the SRL components.

An SRL is encased in a durable housing that contains a spring-loaded drum. This drum is the core mechanism that winds and unwinds the lifeline. The lifeline is a strong, flexible line (often made of steel cable, synthetic rope, or webbing) that connects the worker’s harness to the SRL. The lifeline extends and retracts as the worker moves. Inside the drum, a spring keeps tension on the lifeline, automatically retracting it when slack is created (e.g., when the worker moves closer to the anchor point). The SRL includes an inertia-based locking mechanism (like a centrifugal brake) that engages if the lifeline is pulled out too quickly, such as during a fall. The top of the SRL attaches to a secure anchor point above the worker, capable of withstanding fall forces. At the end of the lifeline, there’s typically a snap hook or carabiner that attaches to the worker’s harness.

As the worker moves, the lifeline extends from the SRL drum smoothly. The spring inside the drum maintains light tension, retracting the lifeline when the worker moves closer to the SRL, keeping slack to a minimum. This allows freedom of movement without the worker needing to manually adjust the line. If the worker falls, the lifeline is yanked out at a high speed. The sudden acceleration triggers the braking system (often a pawl-and-ratchet or friction brake design), locking the drum and stopping the lifeline’s extension within a very short distance—typically 2 feet (0.6 meters) or less, depending on the model. This rapid arrest minimizes the fall distance and reduces the force transmitted to the worker’s body. Once the fall is arrested, the SRL remains locked until tension is released. Conventional SRLs require inspection or servicing after a fall to ensure the internal components (e.g., lifeline, brake, spring) are still functional.

Lifelines that are part of a SRL for fall protection are critical components designed to arrest a fall while minimizing the forces exerted on the worker. Materials used in SRL lifelines may include the following. Synthetic fibers, such as polyester may be used due to its high tensile strength, abrasion resistance, and ultraviolet (UV) resistance. Nylon provides good strength and elasticity but may degrade faster under UV exposure compared to polyester. High-molecular-weight polyethylene (HMWPE) is ultra-strong, lightweight, and resistant to abrasion and chemicals, making it ideal for high-performance SRLs. Galvanized or stainless steel cable may be used in environments where durability and resistance to cutting or harsh conditions (e.g., sharp edges, extreme weather) are critical. Stainless steel is preferred in corrosive environments like marine or chemical settings. Aramid fibers may occasionally be used in specialized SRLs for their heat resistance and exceptional strength, though they’re less common due to cost. The choice of material depends on the specific application—whether it’s general construction, industrial maintenance, or work near sharp edges or extreme heat.

For certification and requirements, SRLs, including their lifelines, must meet strict standards to ensure safety. In the United States and internationally, these devices are regulated by organizations like Occupational Safety and Health Administration (OSHA), American National Standards Institute (ANSI), and others. Key certification requirements include the following. ANSI Z359 Standards (United States): SRLs fall under the ANSI Z359 Fall Protection Code, specifically: ANSI Z359.14, which covers Self-Retracting Devices (SRDs), including SRLs. It classifies SRLs into categories such as SRL (standard), SRL-R (with rescue capability), and SRL-LE (leading edge). Lifelines must withstand specific tensile strength tests (e.g., 3,600 lbs. (pounds) minimum breaking strength for connectors and lifeline materials). For LE applications, the lifeline must resist cutting or abrasion from sharp edges during a fall. Testing includes dynamic performance (arresting a fall within a maximum distance, typically 42 inches, with forces not exceeding 1,800 lbs.) and static strength.

For OSHA regulations: OSHA 1926.502 (Construction) and 1910.140 (General Industry) require fall protection systems, including SRLs, to meet ANSI standards or equivalent. Lifelines must be capable of supporting at least 5,000 lbs. per worker or be part of a system designed with a safety factor of 2.

For EN 360 (Europe): in the European Union, SRLs are certified under EN 360, which specifies that lifelines must arrest a fall safely, with a maximum arrest force of 6 kN (kilonewton; about 1,350 lbs.) and durability under repeated use.

For Canadian Standards Association (CSA) Z259.2.2: similar to ANSI, this standard requires SRLs to meet dynamic and static strength tests, with lifelines designed to handle environmental stressors like temperature extremes.

Manufacturer-Specific Testing: beyond regulatory standards, manufacturers often subject lifelines to additional tests for UV resistance, abrasion, chemical exposure, and wear over time, depending on the intended use.

Additional Requirements needed include inspection and maintenance. Lifelines must be inspected before each use for wear, cuts, or degradation, as specified by manufacturers and standards like ANSI Z359.1.

The lifeline must be compatible with the SRL housing, connectors (e.g., carabiners), and anchor points, ensuring the entire system functions as intended.

Labeling requirements include that certified SRLs must be labeled with the standard (e.g., ANSI Z359.14), class, and maximum weight capacity (typically 310 lbs. or 420 lbs. with additional testing).

Some embodiments address the following problems with conventional SRLs. All SRLs are required to be inspected daily, prior to use. Upon inspection, there are a number of components and/or criteria that must be met enabling the device to be deployed. One of the more critical inspection items is that of the lifeline. If there is wear or damage to the lifeline, it must be “serviced.” Servicing is a broad term and accomplished in a variety of ways. The end user needs to send the SRL into an authorized repair center for inspection and recommended repair. If the inspection yields problems with the lifeline, it needs to be replaced. Lifelines are one of, if not the most commonly replaced SRL components. Nearly every SRL that is serviced receives a new lifeline. Lifelines, from new, may be damaged the instant the device is deployed into the field. The process of sending an SRL in for repair is time consuming, creates job site downtime, and can add considerable expense to the overall maintenance costs. Some embodiments provide that the end user can replace the lifeline in the field (by a predetermined, competent individual), which saves time and cost. Some of the benefits of one or more embodiments include that there is no downtime on the jobsite due to shipping the SRL to a repair center. End users typically buy additional SRLs to account for the time loss incurred by those being sent out for repair. The purchase of additional SRLs is a considerable expense. One or more embodiments provide a solution that reduces the number of SRLs needed in inventory. That is, it is much easier to inventory replacement lifelines instead of complete SRLs. This also eliminates the cost of freight to and from repair center. Additionally, the overall cost savings due to the repair center not having to conduct inspection saves costs as there is typically a flat rate charged for inspection.

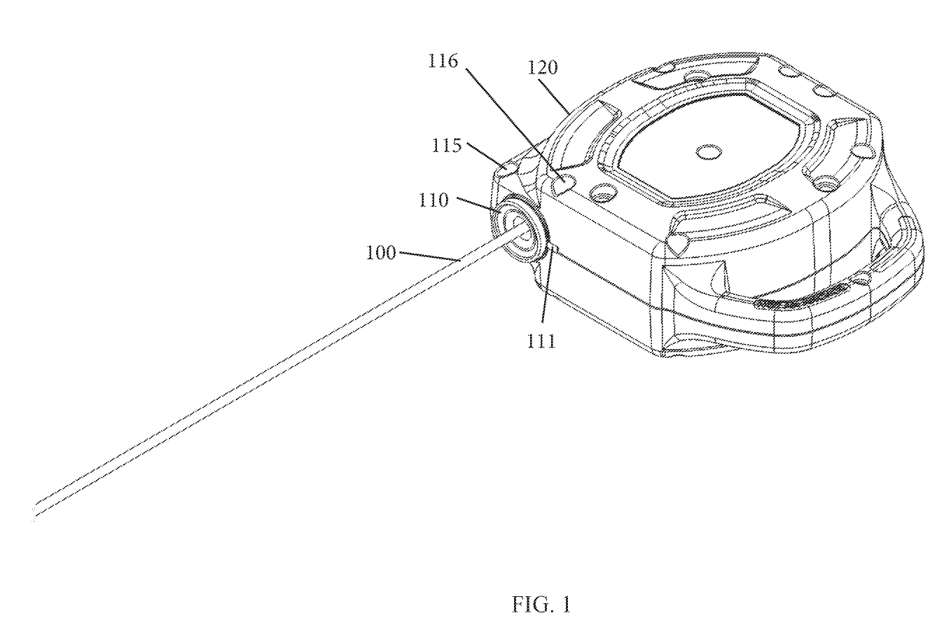

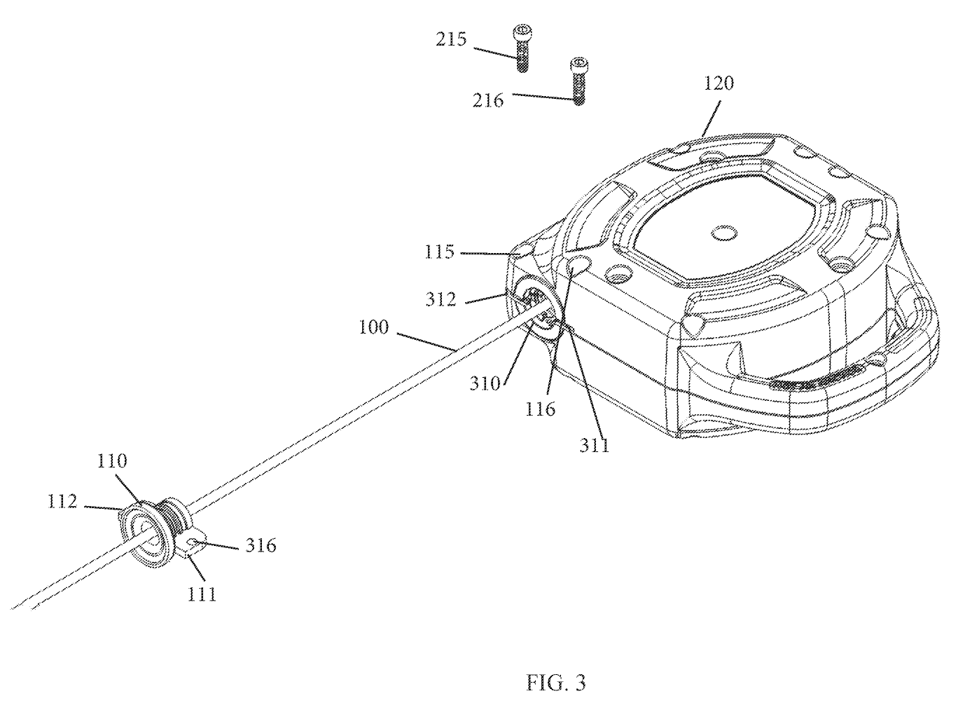

FIG. 1 illustrates an example SRL with a field-replaceable damaged lifeline 100 from a fall event, according to some embodiments. The example SRL includes a housing 120, a lifeline 100, and internal components for retracting and locking the lifeline in place. The system is designed to ensure safety and usability, while allowing for efficient field replacement of a damaged lifeline. In some embodiments, the SRL includes an orifice component 110 including through-hole portions 111 and 112 (FIG. 3), and fastener guide holes 115 and 116.

In one or more embodiments, the materials for the components may include the following or substituted as required. For instance, the lifeline 100 may be nylon 66 with 20% or 30% glass fill, 4140 steel may be an overseas equivalent, etc. The SRL housing 120 may include nylon 66 with 30% glass fill. The orifice component 110 may be molybdenum disulfide filled nylon, etc.

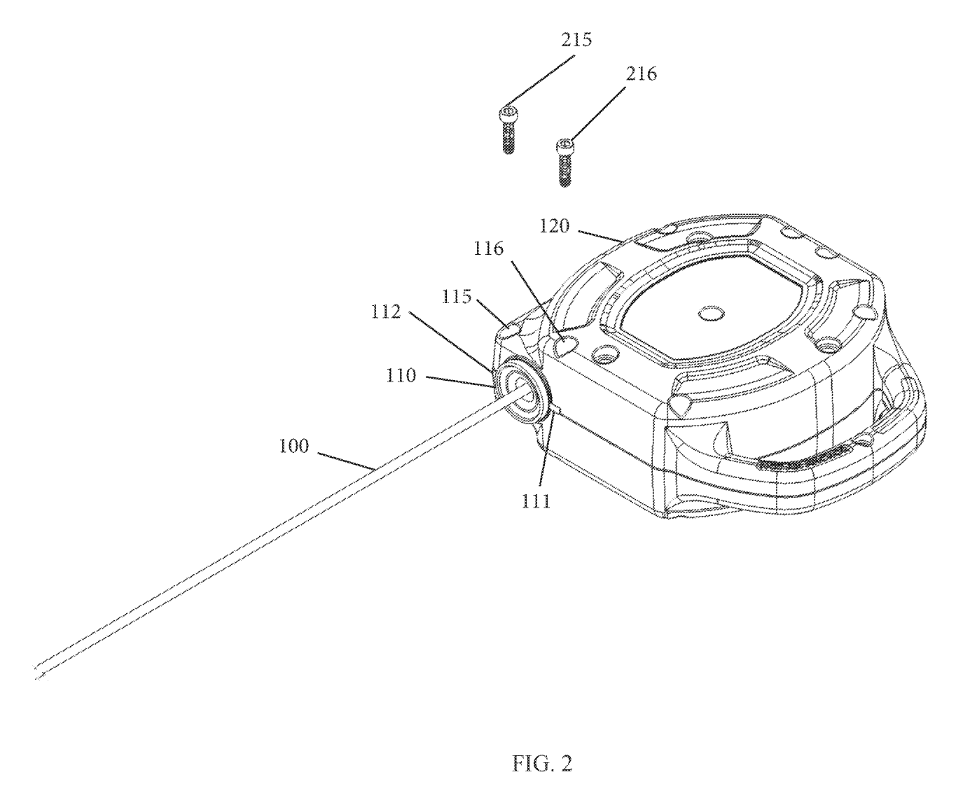

FIG. 2 illustrates the example SRL with the field-replaceable damaged lifeline 100 from a fall event with housing fasteners 215 and 216 (e.g., bolts, screws, etc.) respectably removed from the fastener guide holes 115 and 116 or the housing 120 and orifice component 110 through-hole portions 111 and 112, according to some embodiments. As illustrated, in some embodiments the SRL housing fasteners 215 and 216 are removed from the housing 120 to release the orifice component 110 from the housing 120. In one or more embodiments, once the housing fasteners 215 and 216 are detached, the orifice component 110 can be separated from the housing 120 as shown in FIG. 3.

FIG. 3 illustrates the example SRL with the field-replaceable damaged lifeline 100 from a fall event with the orifice component 110 removed from the housing 120, according to some embodiments. As shown, in some embodiments the orifice component 110 includes through-holes 316 on through-hole portions 111 and 112 that are fastened via housing fasteners 215 and 216. In one or more embodiments, the housing 120 includes an opening 310 and openings or slots 311 and 312 for the through-hole portions 111 and 112 to be seated within the housing 120.

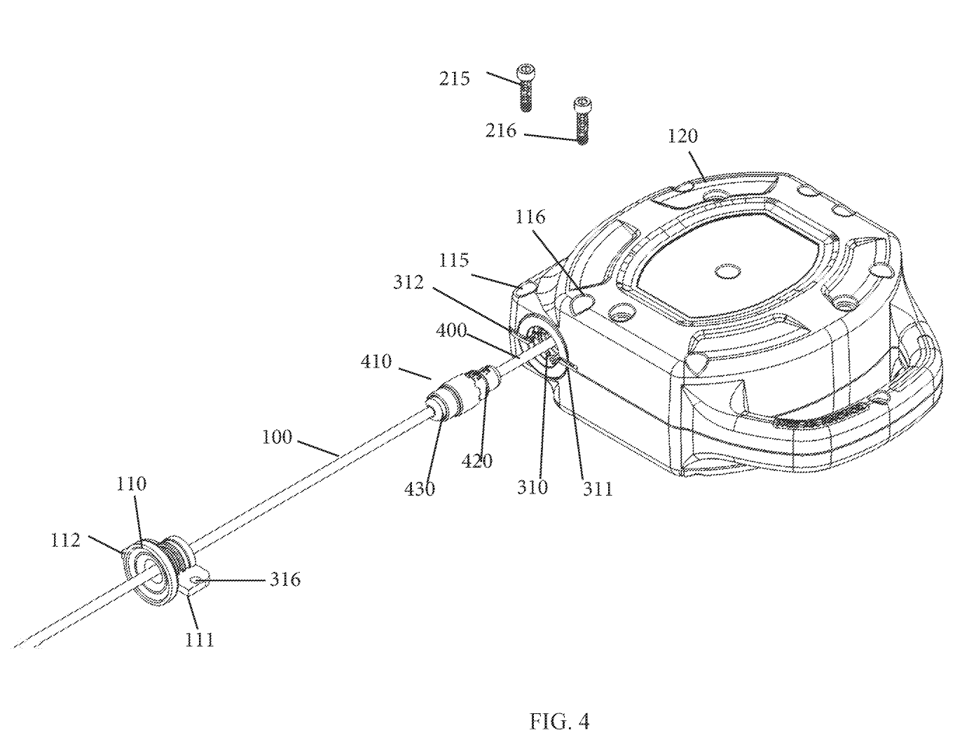

FIG. 4 illustrates the example SRL with the field-replaceable damaged lifeline 100 from a fall event with the cable 400 pulled out of the SRL showing a coupling component 410 that includes a hook-side jacket 430 and a drum side jacket 420 removed from the drum-side of the SRL, according to some embodiments. In one or more embodiments, the jacket 410 may be made of 4140 steel, zinc plated, etc.

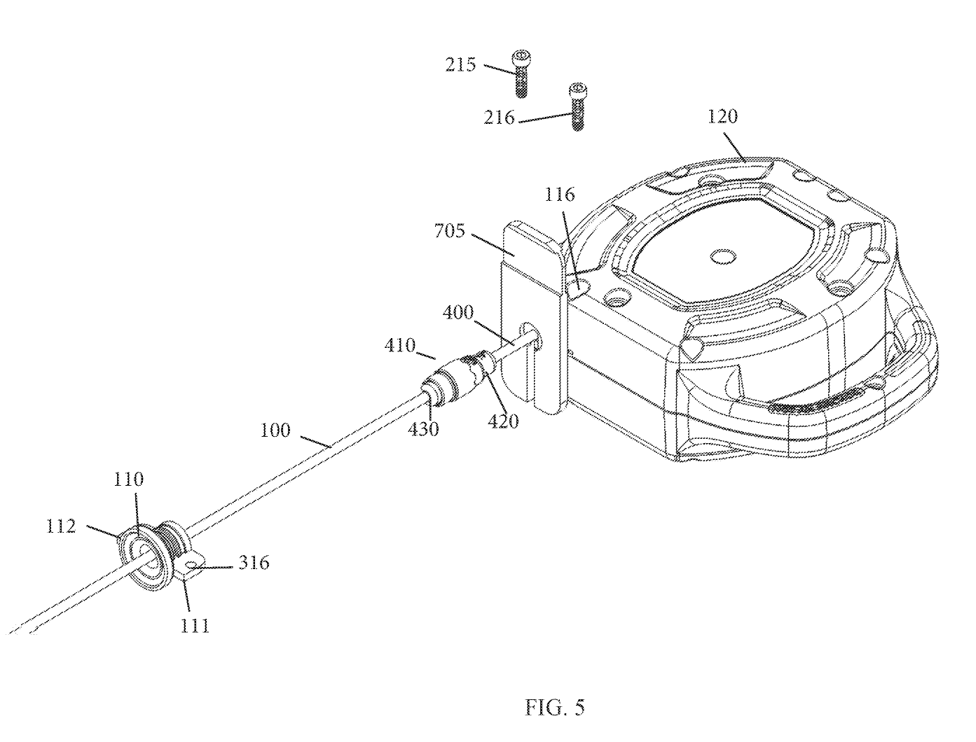

FIG. 5 illustrates the example SRL with the field-replaceable damaged lifeline 100 from a fall event with a specialized tool 705 used to retain the cable 400 outside of the SRL housing 120, according to some embodiments. The specialized tool 705 is employed for ensuring stability during replacement.

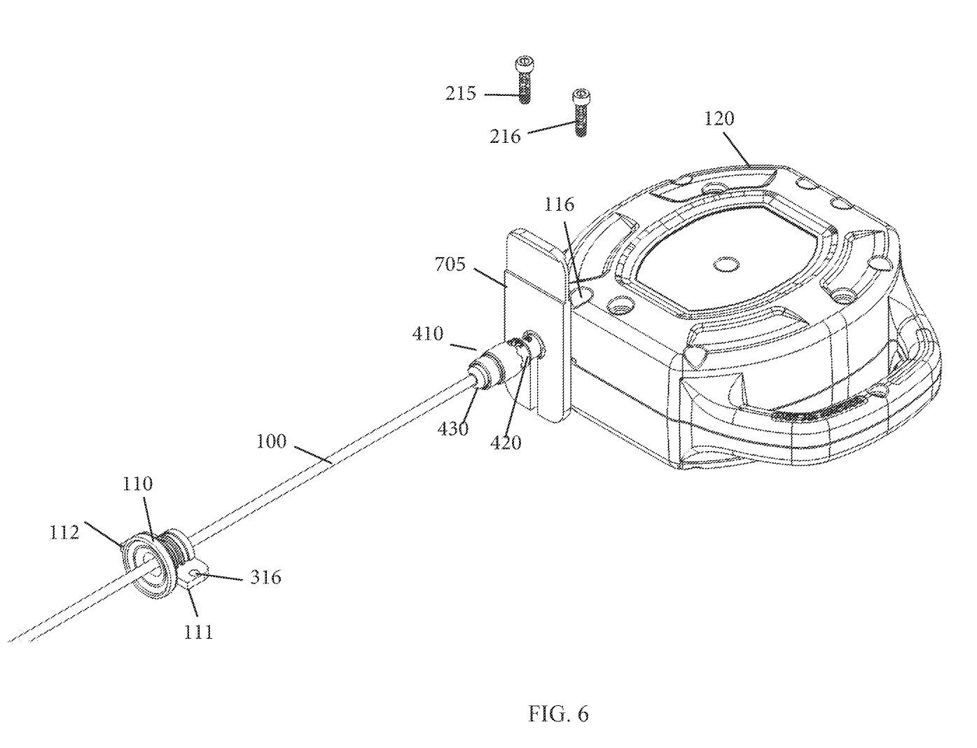

FIG. 6 illustrates the example SRL with the field-replaceable damaged lifeline 100 from a fall event with the cable 400 released to seat the coupling component 410 into the specialized tool 705, according to some embodiments. As shown, the specialized tool 705 has a slot for placing the specialized tool 705 over the cable 400 and an opening for seating the drum side jacket 420.

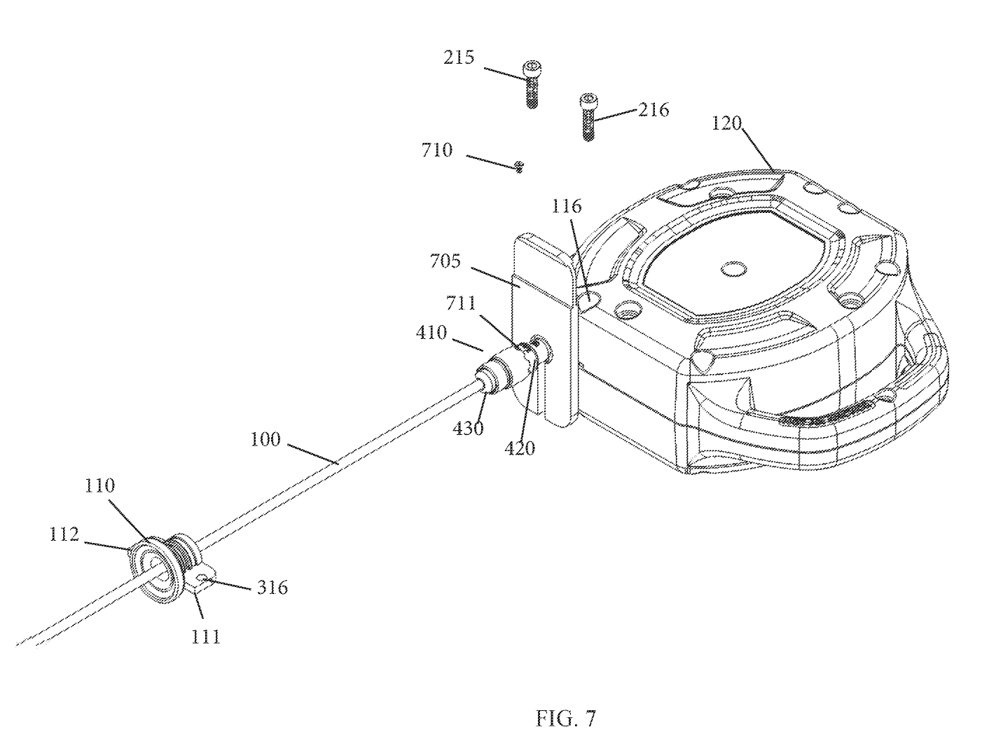

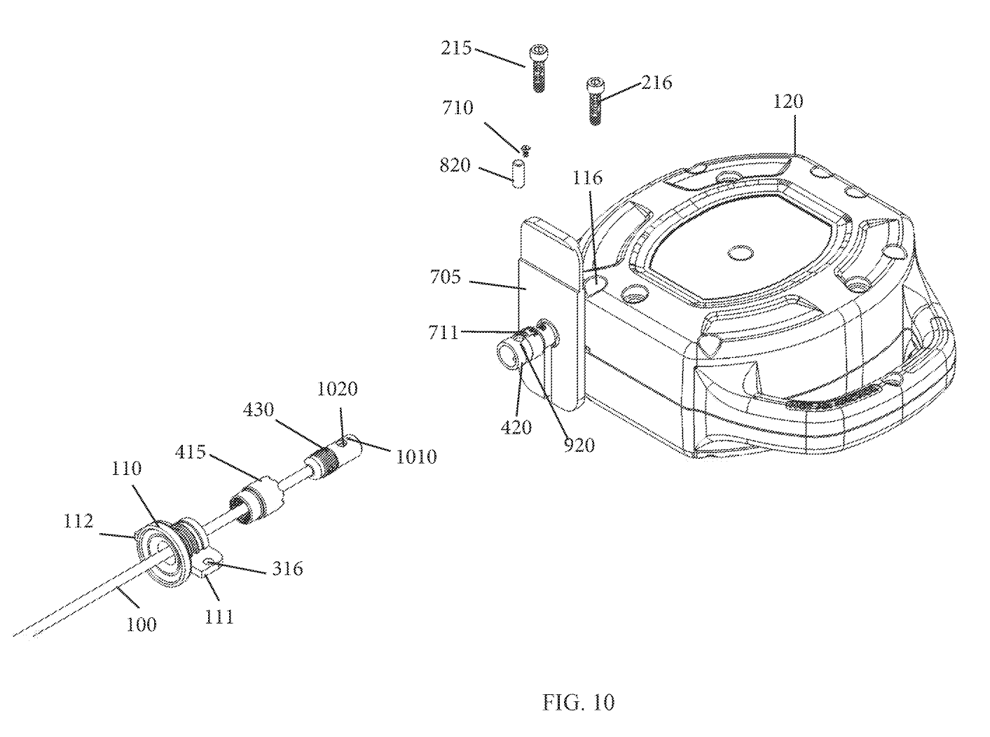

FIG. 7 illustrates the example SRL with the field-replaceable damaged lifeline 100 from a fall event with a lock fastener 710 removed from the coupling component 410, according to some embodiments. As shown, in one or more embodiments, the lock fastener 710 is removed from a corresponding opening 711 in the coupling component 410. In some embodiments, the lock fastener 710 may be a fastener such as a set screw, etc. In one embodiment, the lock fastener 710 is placed into the opening 711 and unthreaded from the setting portion 1010 (FIG. 10) for removal from the drum side jacket 420 providing for further disassembly.

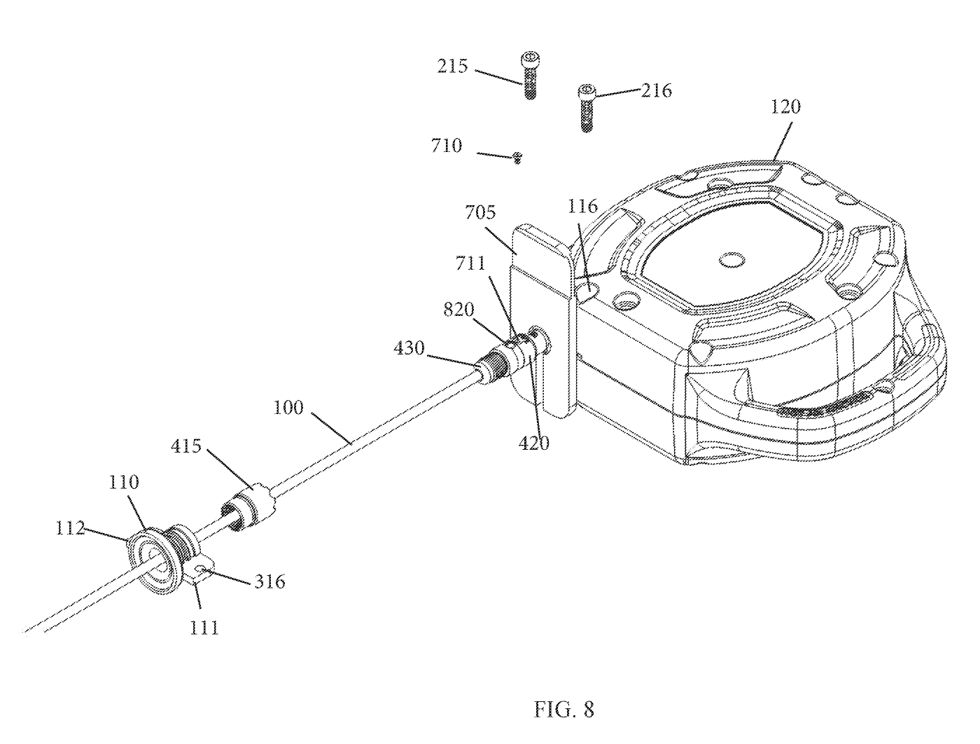

FIG. 8 illustrates the example SRL with the field-replaceable damaged lifeline 100 from a fall event with a locking ring 415 moved away from the coupling component 410, according to some embodiments. As shown, the removal of the locking ring 415 exposes a locking pin 820 that locks the hook-side jacket 430 to the drum side jacket 420. The locking pin 820 works along with the lock fastener 710 that sets in the setting portion 1010 (FIG. 10).

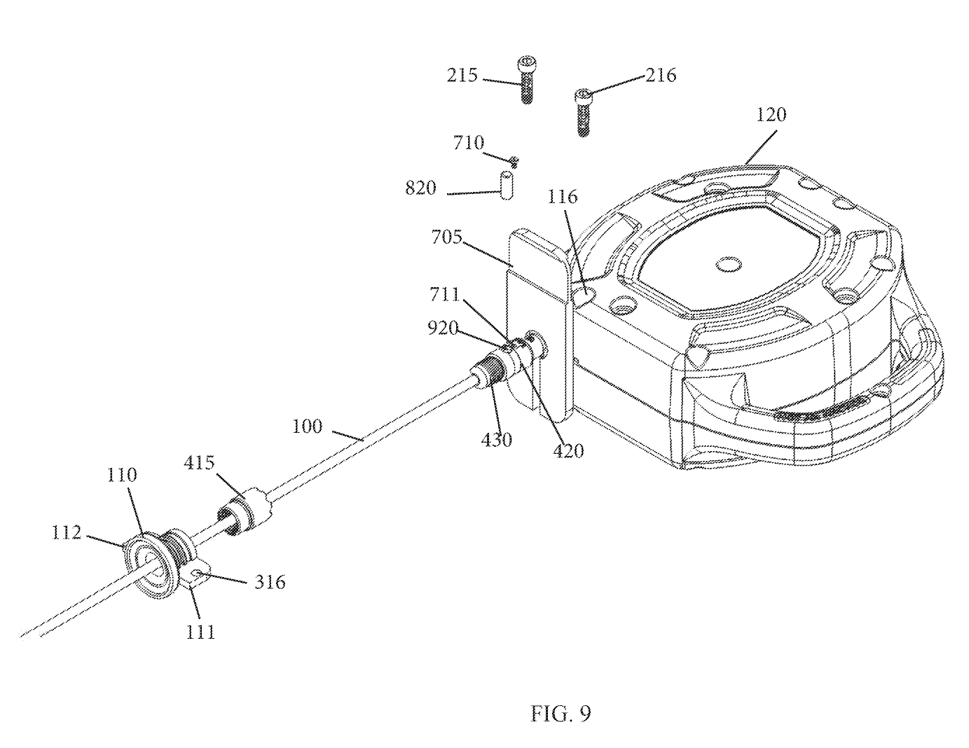

FIG. 9 illustrates the example SRL with the field-replaceable damaged lifeline 100 from a fall event with the locking pin 820 removed from the locking pin opening 920 of the drum-side jacket 420, according to some embodiments.

FIG. 10 illustrates the example SRL with the field-replaceable damaged lifeline 100 from a fall event with a hook-side jacket 430 of the jacket 410 removed from the drum-side jacket 420, according to some embodiments. As shown, the hook-side jacket 420 includes the setting portion 1010 and pin placement portion 1020.

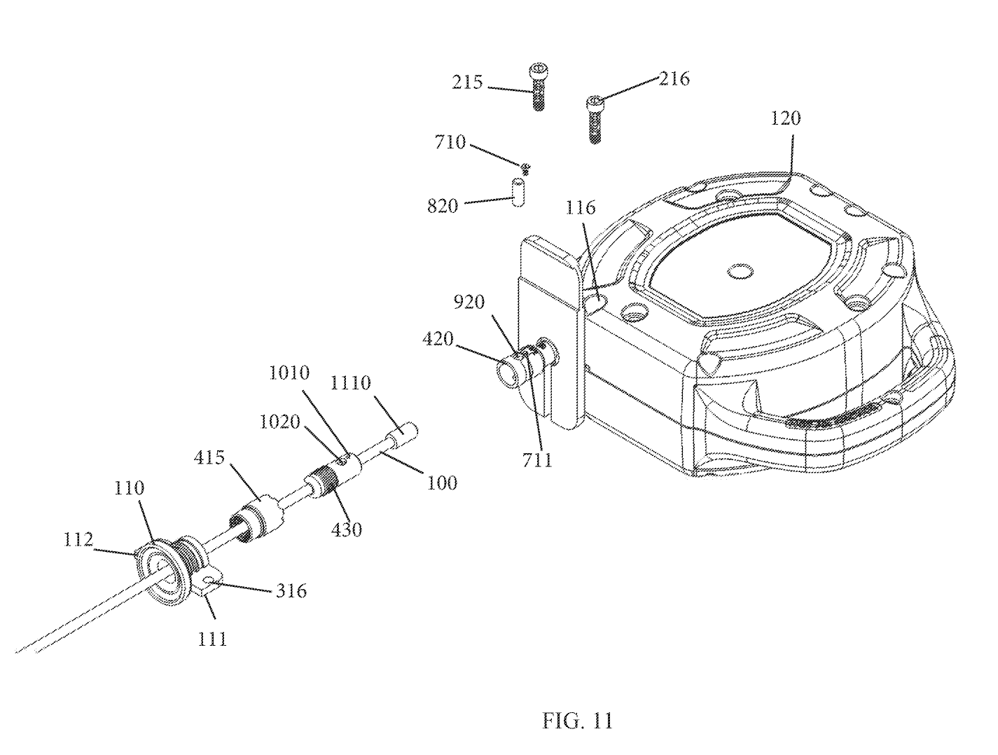

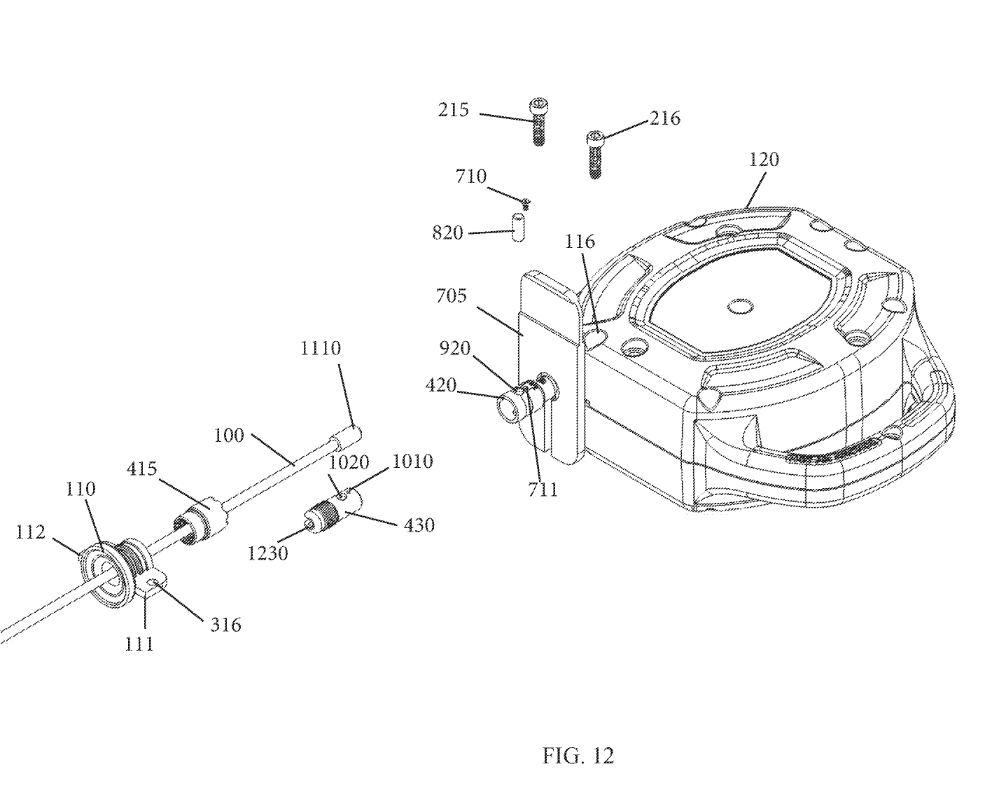

FIG. 11 illustrates the example SRL with the field-replaceable damaged lifeline 100 from a fall event with the damage line 100 moved out of a counterbore portion 1230 (FIG. 12) of the hook-side jacket 420, according to some embodiments. As shown, the damaged lifeline 100 includes a bore end 1110 that lodges in the counterbore portion 1230 of the hook-side jacket 420.

FIG. 12 illustrates the example SRL with the field-replaceable damaged lifeline 100 from a fall event removed from the hook-side jacket 430 through the counterbore portion 1230, according to some embodiments.

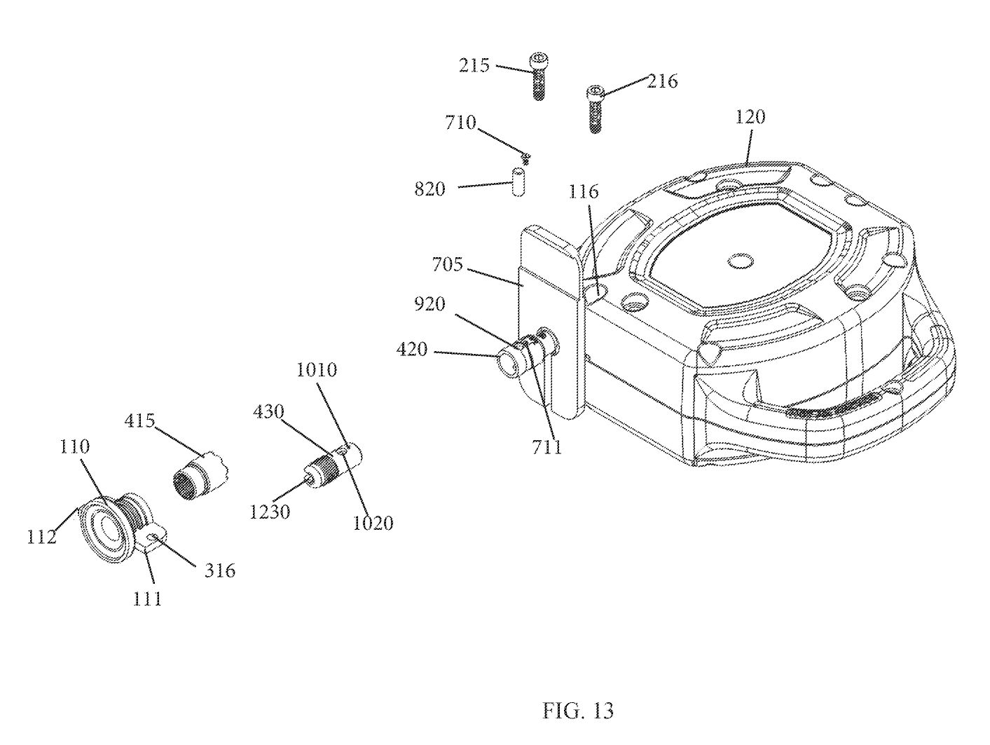

FIG. 13 illustrates the example SRL with the field-replaceable damaged lifeline 100 removed, according to some embodiments. In one embodiment, the damaged lifeline 100 is pulled or slid out from the locking ring 415 and the orifice component 110 once removed from the counterbore portion 1230 of the hook-side jacket 430.

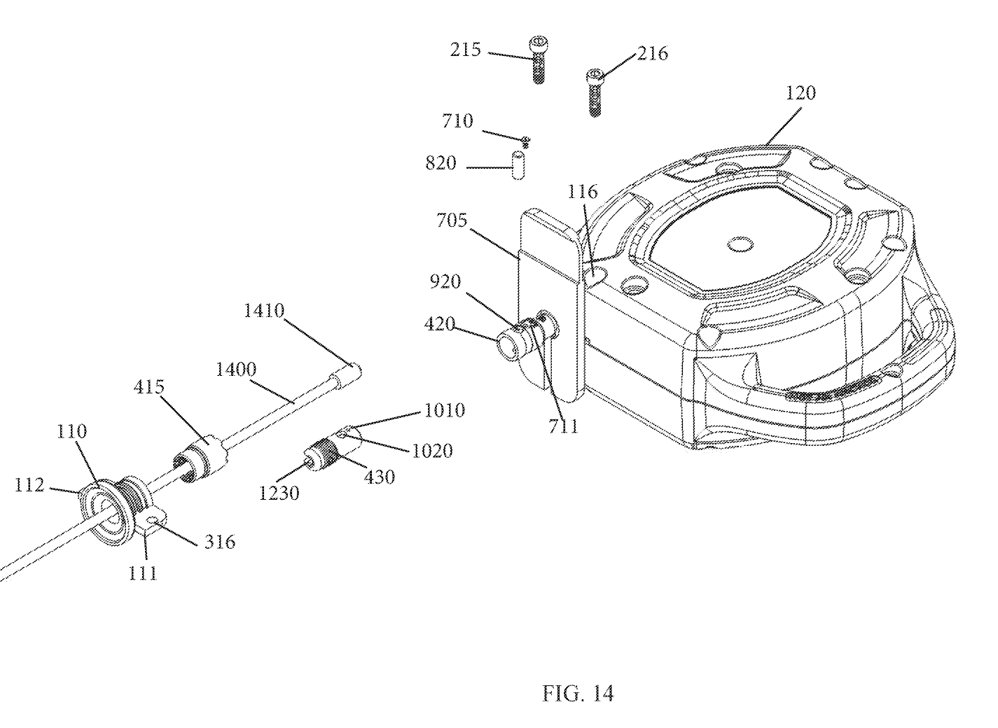

FIG. 14 illustrates the example SRL with a new lifeline 1400 replacing the damaged lifeline 100 with the new lifeline 1400 inserted through the orifice component 110 and the locking ring component 415, according to some embodiments.

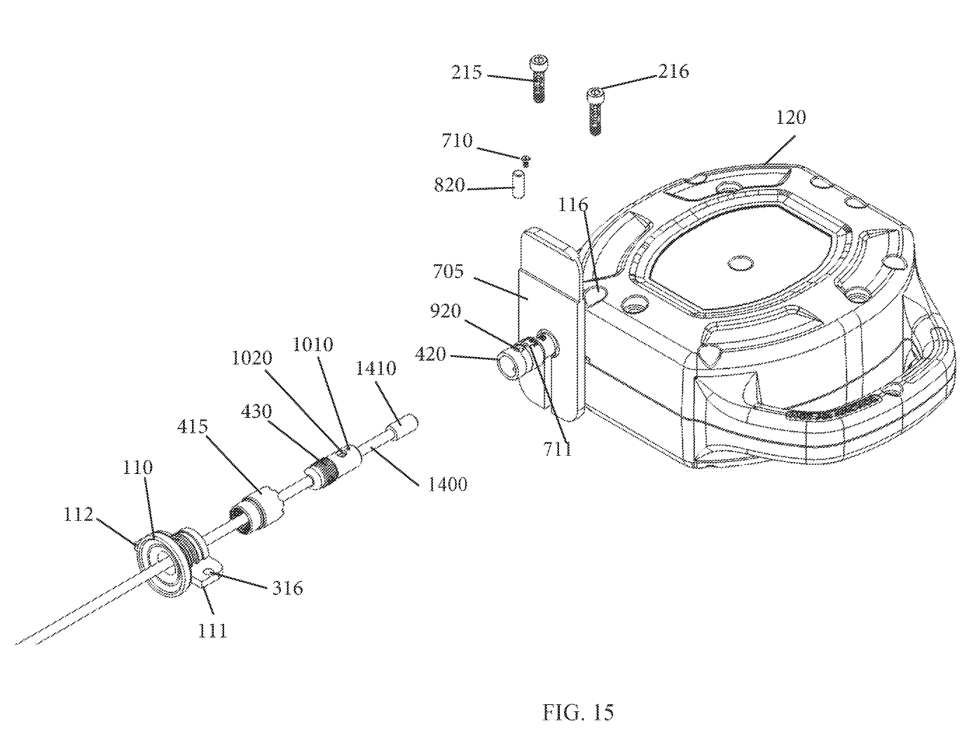

FIG. 15 illustrates the example SRL with the new lifeline 1400 moved through the counterbore portion 1230 of the hook-side jacket 430, according to some embodiments.

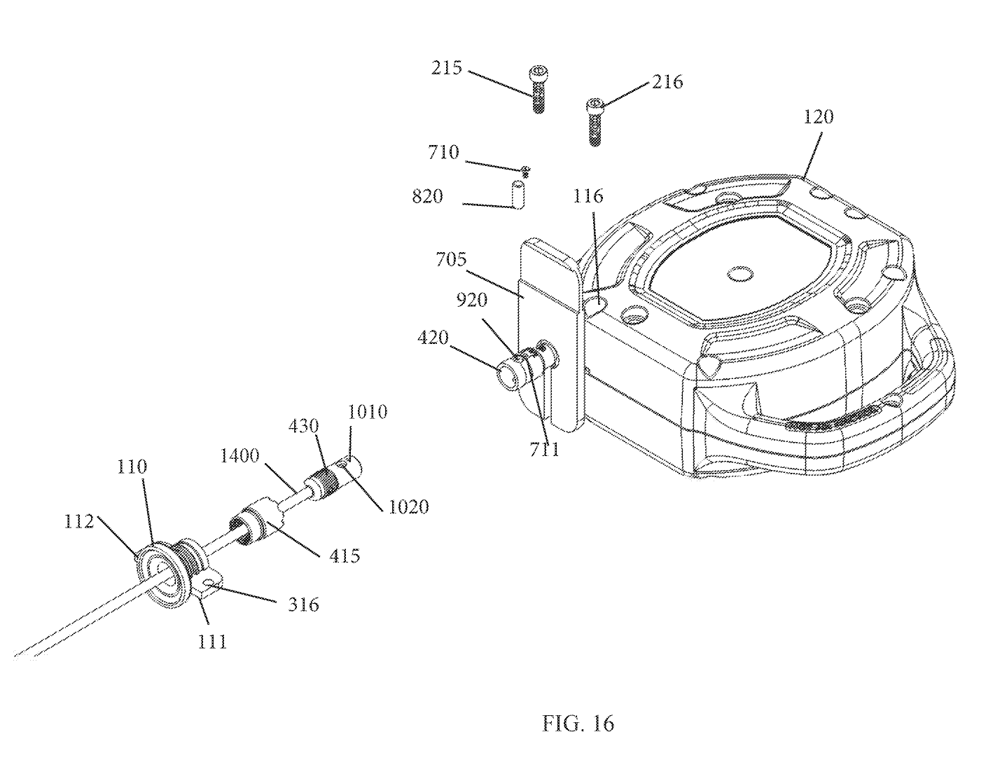

FIG. 16 illustrates the example SRL with the new lifeline 1400 seated into the counterbore portion 1230 of the hook-side jacket 430, according to some embodiments.

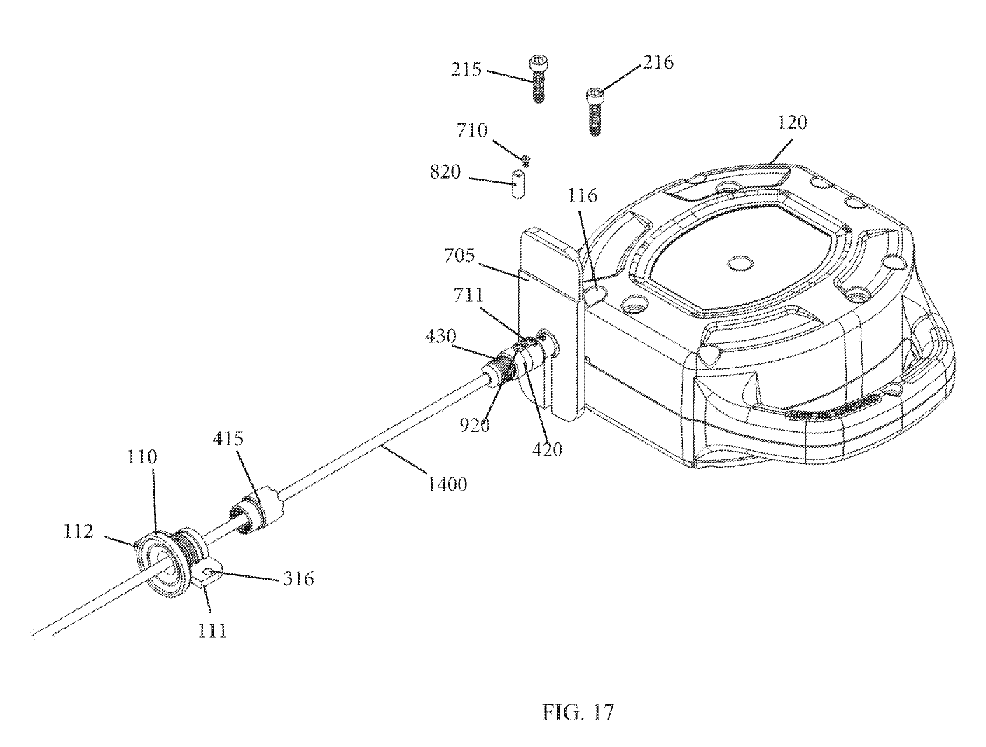

FIG. 17 illustrates the example SRL with the new lifeline 1400 with the hook-side jacket 430 inserted into the drum-side jacket 420, according to some embodiments.

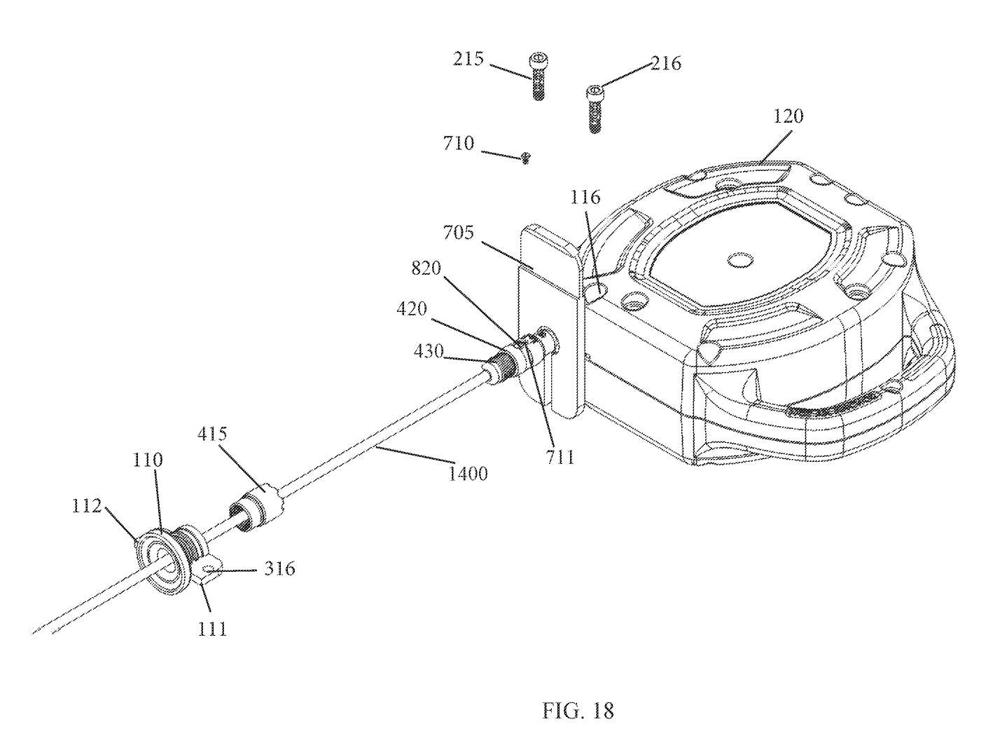

FIG. 18 illustrates the example SRL with the new lifeline 1400 with the locking pin 820 inserted through both the hook-side jacket 430 and the drum-side jacket 420, according to some embodiments. The locking pin is seated in the locking pin opening 920 (FIG. 9) ensuring a secure fit.

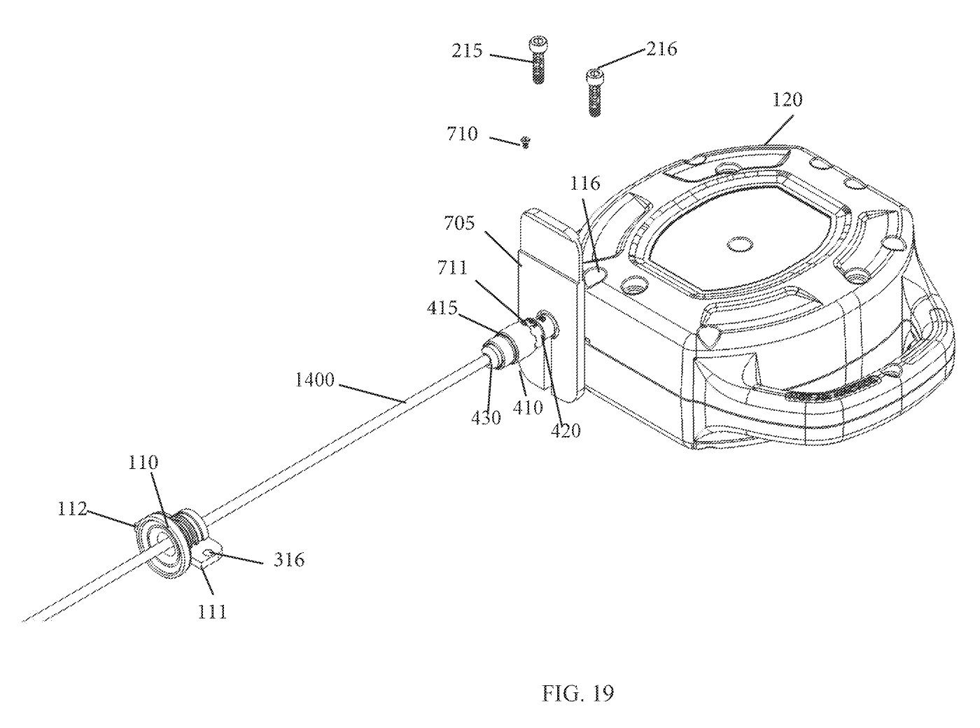

FIG. 19 illustrates the example SRL with the new lifeline 1400 with the locking component 415 threaded on the hook-side jacket 430 to align a portion with the opening 711 of the drum-side jacket 420, according to some embodiments.

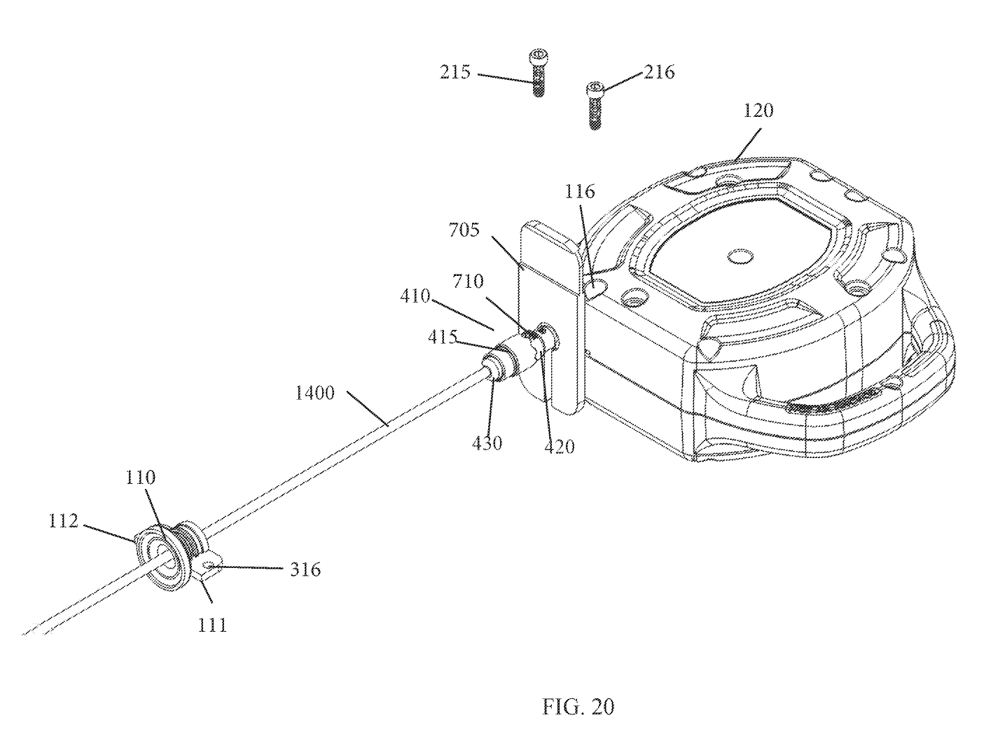

FIG. 20 illustrates the example SRL with the new lifeline 1400 with the lock fastener 710 inserted through both the hook-side jacket 430 and the drum-side jacket 420, according to some embodiments. The lock fastener 710 is locked into the opening 711 (e.g., threaded, etc.). Thus, the new lifeline 1400 is secured within the coupling component 410.

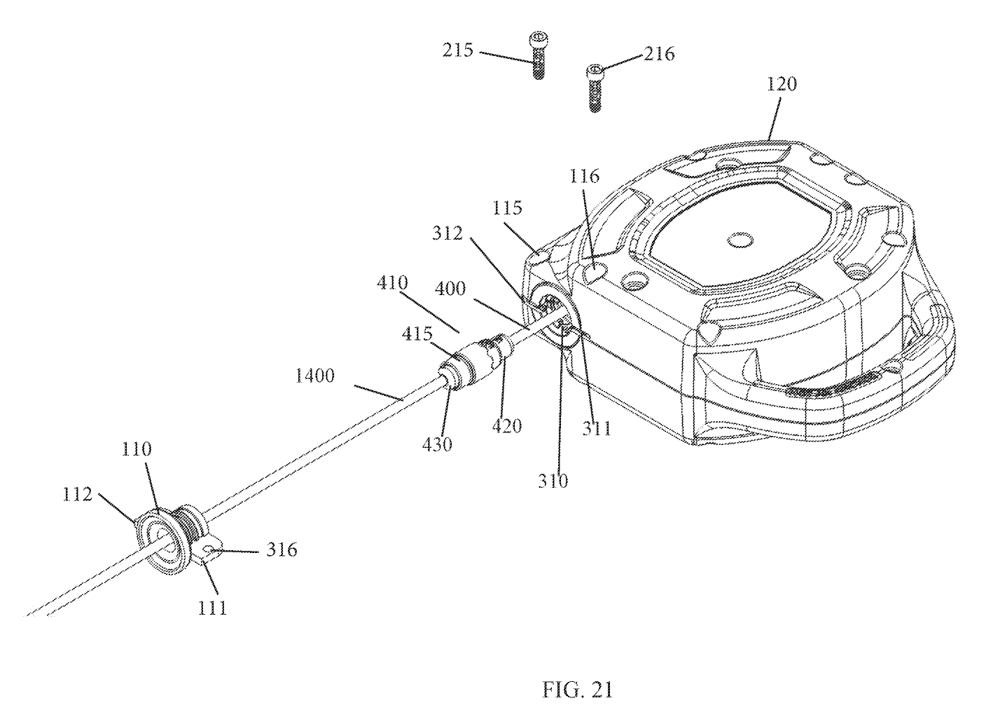

FIG. 21 illustrates the example SRL with the new lifeline 1400 with the specialized tool 705 removed, according to some embodiments. The removal of the specialized tool 705 permits the retraction of the coupling component 410 into the opening 310 of the housing 120.

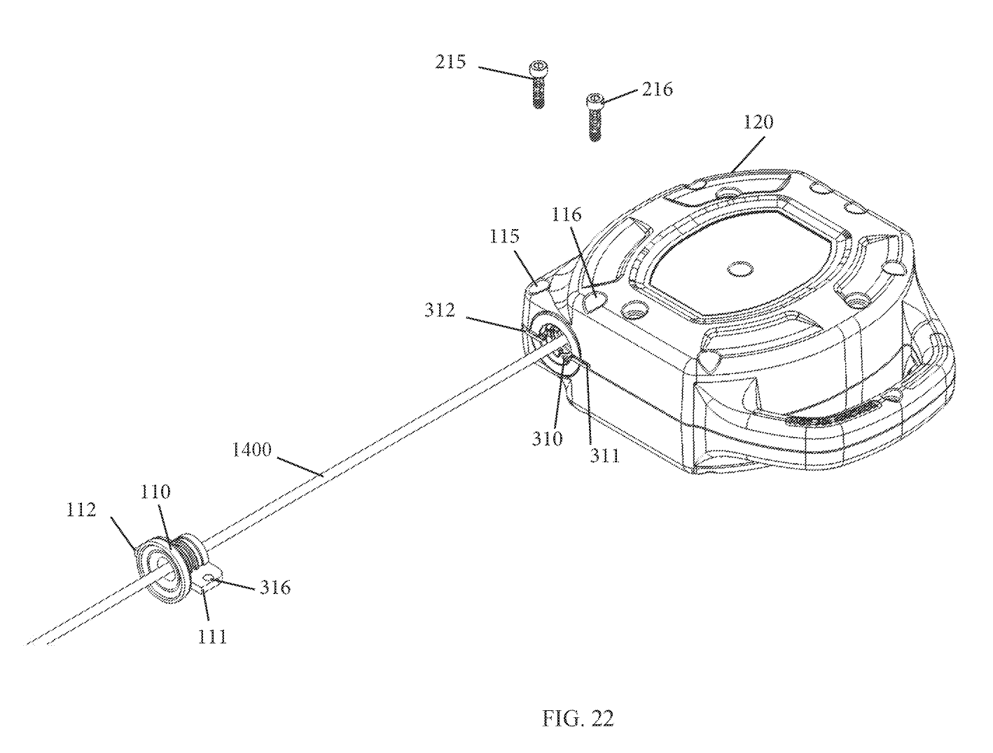

FIG. 22 illustrates the example SRL with the new lifeline 1400 with the coupling component 410 retracted back into the housing 120, according to some embodiments.

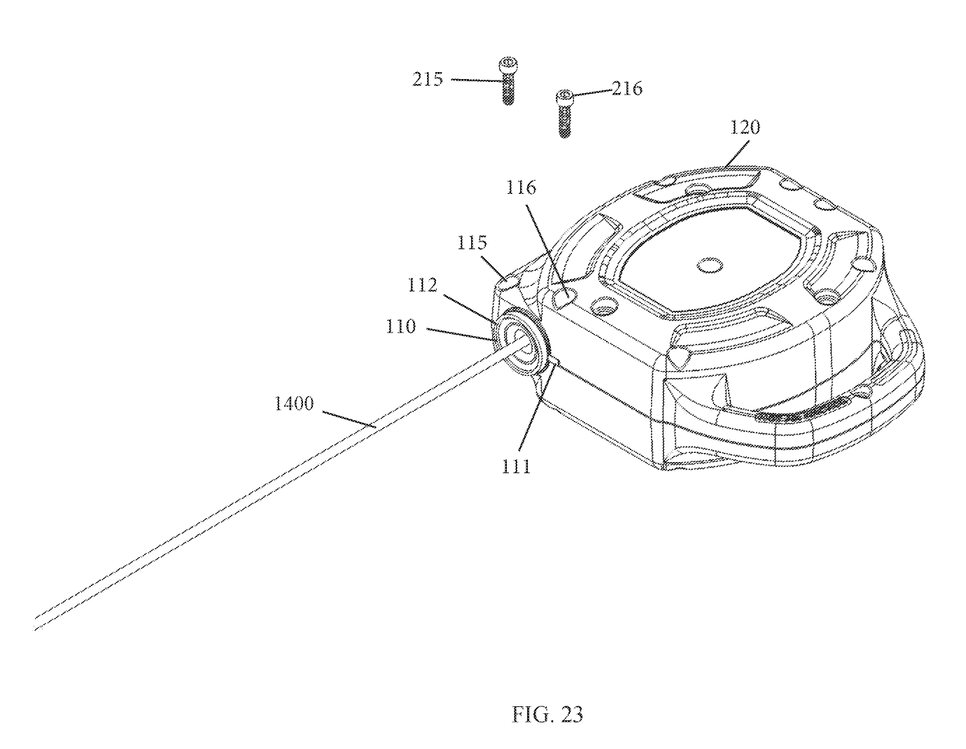

FIG. 23 illustrates the example SRL with the new lifeline 1400 with the orifice component 110 inserted back into the housing 120, according to some embodiments.

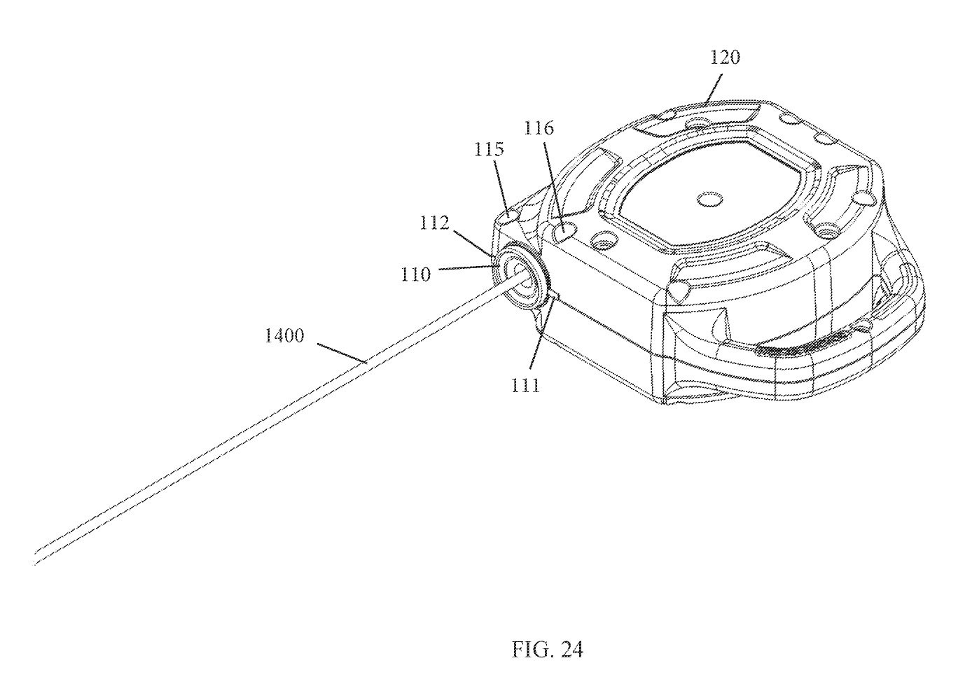

FIG. 24 illustrates the example SRL with the new line 1400 with the housing fasteners 215 and 216 inserted back into the housing 120 securing the orifice component 110, according to some embodiments. This results in the damaged lifeline 100 being replaced with the new lifeline 1400. Thus, the SRL is ready for use again in the field without having to be sent off for repair or replaced with another SRL.

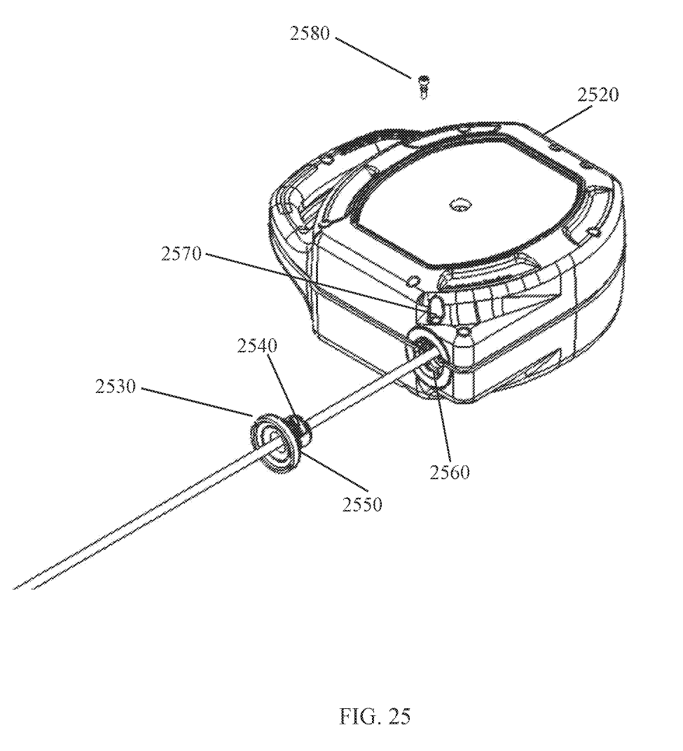

FIG. 25 illustrates another example SRL with a field-replaceable lifeline with another embodiment of an orifice component 2530, according to some embodiments. In some embodiments, the orifice component 2530 includes a slot/opening 2540 and threading 2550. In some embodiments, the orifice component 2530 is threaded into threads 2560 of the housing 2520 for the SRL. When threaded into the housing 2520, a bolt/fastener 2580 is inserted into an opening 2570 and into the slot/opening 2540. In one or more embodiments, the bolt/fastener 2580 includes marking (e.g., paint, etc.) for indicating tampering. Other embodiments of the orifice component 2530 may be designed without altering the functionality. As with the previous discussed embodiments above, the method of replacing a damaged lifeline is similar with the orifice component 2530 except for the differences of attaching the orifice component 2530 to the housing 2520.

These embodiments provide an efficient and safe method or process for replacing a damaged lifeline in an SRL, ensuring continued usability and compliance with safety standards without requiring complete unit replacement. The embodiments include a complete step-by-step instructional guide for inspection and replacement of the field-replaceable lifeline in the field according to applicable standards that must be followed.

In the description above, numerous specific details are set forth. However, it is understood that embodiments of the invention may be practiced without these specific details. For example, well-known equivalent components and elements may be substituted in place of those described herein, and similarly, well-known equivalent techniques may be substituted in place of the particular techniques disclosed. In other instances, well-known structures and techniques have not been shown in detail to avoid obscuring the understanding of this description.

Reference in the specification to "an embodiment," "one embodiment," "some embodiments," or "other embodiments" means that a particular feature, structure, or characteristic described in connection with the embodiments is included in at least some embodiments, but not necessarily all embodiments. The various appearances of "an embodiment," "one embodiment," or "some embodiments" are not necessarily all referring to the same embodiments. If the specification states a component, feature, structure, or characteristic "may", "might", or "could" be included, that particular component, feature, structure, or characteristic is not required to be included. If the specification or claim refers to "a" or "an" element, that does not mean there is only one element. If the specification or claims refer to "an additional" element, that does not preclude there being more than one of the additional elements.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A self-retracting lifeline (SRL) with a field-replaceable lifeline, comprising:
a housing configured to enclose a retractable cable removably coupled to a field-replaceable lifeline;
an orifice component removably coupled to the housing through which the field-replaceable lifeline extends; and
a removable coupling component secures the lifeline and is retained by the orifice component within the housing, wherein the coupling component provides for removing and replacing of the field-replaceable lifeline.

2. The SRL with the field-replaceable lifeline of claim 1, wherein the coupling component comprises a locking ring, a hook-side jacket and a drum-side jacket.

3. The SRL with the field-replaceable lifeline of claim 2, wherein a specialized tool is removably coupled to the drum-side jacket during replacement of the field-replaceable lifeline.

4. The SRL with the field-replaceable lifeline of claim 2, wherein the hook-side jacket includes a counterbore to seat a bore of the field-replaceable lifeline.

5. The SRL with the field-replaceable lifeline of claim 2, wherein the hook-side jacket and the drum-side jacket are configured for interlocking engagement.

6. The SRL with the field-replaceable lifeline of claim 2, wherein a first end of the retractable cable is coupled to a drum within the housing, and a second end of the retractable cable is coupled to the drum-side jacket.

7. The SRL with the field-replaceable lifeline of claim 2, further comprising:
one or more fasteners that removably couple the orifice component to the housing; and
a locking pin that removably couples the drum-side jacket to the hook-side jacket.

8. A self-retracting lifeline (SRL) system comprising:
a cable having a first end coupled to a retracting drum component of the SRL within a housing, and a second end coupled to a drum-side jacket of a coupling component; and
an orifice component removably coupled to the housing through which a field-replaceable lifeline extends;
wherein the coupling component secures the field-replaceable lifeline within the housing and is retained by the orifice component, and the coupling component provides for removing and replacing the field-replaceable lifeline.

9. The SRL system of claim 8, wherein the coupling component comprises a locking ring, a hook-side jacket and the drum-side jacket.

10. The SRL system of claim 9, wherein a specialized tool is removably coupled to the drum-side jacket during replacement of the field-replaceable lifeline.

11. The SRL system of claim 9, wherein the hook-side jacket includes a counterbore to seat a bore of the field-replaceable lifeline.

12. The SRL system of claim 9, wherein the hook-side jacket and the drum-side jacket are configured for interlocking engagement.

13. The SRL system of claim 9, further comprising:
one or more fasteners that removably couple the orifice component to the housing; and
a locking pin that removably couples the drum-side jacket to the hook-side jacket.

14. The SRL system of claim 9, wherein the field-replaceable lifeline is pre-configured with the drum-side jacket.

15. The SRL system of claim 8, further comprising an instructional guide for replacement of the field-replaceable lifeline.

16. A method for replacing a damaged lifeline in a self-retracting lifeline (SRL), comprising:
removing housing fasteners to release an orifice component from the housing;
extracting the orifice from the housing;
pulling the damaged lifeline from the SRL, exposing a coupling component;
securing the damaged lifeline with a specialized tool that engages a drum-side jacket of the coupling component;
detaching one or more locking fasteners from the coupling component;
removing a locking ring of the coupling component and disengaging a hook-side jacket from the drum-side jacket;
extracting the damaged lifeline from a counterbore portion of the hook-side jacket;
inserting a replacement lifeline through the counterbore portion;
securing the replacement lifeline by re-engaging the locking ring and the one or more locking fasteners;
removing the specialized tool for reinserting the coupling component within the housing;
reinserting the orifice component into the housing; and
securing the housing fasteners to the orifice component to complete the replacement.

17. The method of claim 16, wherein the specialized tool retains the drum-side jacket of the coupling component in a fixed position during replacement.

18. The method of claim 16, further comprising threading the locking ring to the hook-side jacket.

19. The method of claim 16, wherein the method is performed in a field environment without a need for specialized equipment beyond the specialized tool.
